(19) United States
(12) Patent Application Publication
(10) Pub. No.: US 2012/0222100 A1
(43) Pub. Date: Aug. 30, 2012

(54) ADVANCED CAPTCHA USING INTEGRATED IMAGES

(75) Inventors: Frank Clay Fisk, Lawrenceville, GA (US); Sri Ramanathan, Lutz, FL (US); Matthew Adam Terry, Dunwoody, GA (US); Matthew Bunkley Trevathan, Kennesaw, GA (US)

(73) Assignee: INTERNATIONAL BUSINESS MACHINES CORPORATION, Armonk, NY (US)

(21) Appl. No.: 13/034,112

(22) Filed: Feb. 24, 2011

(51) Int. Cl. H04L 9/32; G06F 21/00

(52) U.S. Cl. 726/7

(57) ABSTRACT

An embodiment of the invention is a CAPTCHA program to determine if a user of a computer is a human or a computer program. The program sends to the computer an image and a portion of the image for display. The program receives from the user an indication of where the portion is located within the image. The portion, as displayed, may be altered in various ways. In response to the user properly indicating the location, the program determines that the user of the computer is a human. In response to the user not properly indicating the location, the program determines that the user of the computer is a computer program. In response to determining that the user of the computer is a human, the program grants the user access to information (database, application, program). In response to determining that the user is a computer program, the program denies access.

### BACKGROUND

This disclosure relates generally to information security and more specifically to an advanced CAPTCHA program for allowing or denying access to a resource accessible to a computer.

A CAPTCHA (Completely Automated Public Turing Test To Tell Computers and Humans Apart) is a program that protects websites against automated programs (bots) by generating and grading tests that humans can pass, but current computer programs cannot. For example, humans can read distorted text, but a computer program may not be able to. A CAPTCHA is sometimes referred to as a reverse Turing test, as it is the computer testing a human and not the other way around.

A CAPTCHA acts as a security mechanism by requiring a correct answer to a question, which only a human can answer any better than a random guess. Humans have speed limitations, and hence, cannot replicate the impact of an automated program. Thus the basic requirement of a CAPTCHA is that computer programs must be slower than humans in responding correctly. CAPTCHAs are useful for several applications, including, but not limited to: preventing comment spam in blogs, protecting website registration, protecting e-mail addresses from web scrapers, online polls, preventing dictionary attacks in password systems, and even preventing worms and spam in e-mail.

### SUMMARY

In one embodiment of the invention, a method is disclosed for determining if a user of a client computer system is a human or a computer program. The method comprises a server computer system sending to the client computer system an image and a portion of the image for display on the client computer system, wherein the portion of the image is selected for a location within the image. The method further comprises the server computer system receiving from the user an indication of the location. In response to the user properly indicating the location, the server computer system determines that the user of the client computer system is a human. In response to determining that the user of the client computer system is a human, the server computer system grants the user access to a computer resource.

In another embodiment of the invention, a computer program product is disclosed for determining if a user of a client computer system is a human or a computer program. The computer program product comprises one or more computer-readable tangible storage devices and program instructions stored on at least one of the one or more storage devices. The program instructions comprise program instructions to send to the client computer system an image and a portion of the image for display on the client computer system. The portion of the image is selected from a location within the image. The program instructions further comprise program instructions to receive from the user an indication of the location. In response to the user properly indicating the location, program instructions further comprise instructions to determine that the user of the client computer system is a human. In response to determining that the user of the client computer system is a human, program instructions further comprise instructions to grant the user access to a computer resource. In response to the user not properly indicating the location within image, program instructions comprise instructions to determine that the user is a computer program. In response to determining that the user is a computer program, program instructions comprise instructions to deny the user access to the resource.

In another embodiment a computer system is disclosed for determining if a user of a client computer system is a human or a computer program. The computer system comprises one or more processors, one or more computer-readable memories, one or more computer-readable tangible storage devices and program instructions, which are stored on the one or more storage devices for execution by the one or more processors via the one or more memories. The program instructions comprise instructions to send to the client computer system an image and a portion of the image for display on the client computer system, wherein the portion of the image is selected from a location within the image. The program instructions further comprise program instructions to receive from the user an indication of the location. In response to the user properly indicating the location, program instructions further comprise instructions to determine that the user of the client computer system is a human. In response to determining that the user of the client computer system is a human, program instructions further comprise instructions to grant the user access to a computer resource. In response to the user not properly indicating the location within image, program instructions comprise instructions to determine that the user is a computer program. In response to determining that the user is a computer program, program instructions comprise instructions to deny the user access to the resource.

### BRIEF DESCRIPTION OF THE SEVERAL VIEWS OF THE DRAWINGS

FIG. 1 depicts an illustrative diagram of a data processing environment as a network of data processing systems in which illustrative embodiments may be implemented;

FIG. 2 depicts a flowchart of the steps of CAPTCHA program 114 for determining if a user of a computer is a human or a computer program in accordance with an illustrative embodiment;

FIG. 3 depicts a preferred embodiment of CAPTCHA program 114 for determining if a user of a computer is a human or a computer program;

FIG. 4A depicts a user display where an image is displayed along with portions of the image that have been altered in various ways in accordance with an illustrative embodiment;

FIG. 4B depicts the user display, where the content of the portions of the image has been replaced with different images in accordance with an illustrative embodiment; and

FIG. 5 depicts a block diagram of internal and external components of a data processing system depicted in accordance with an illustrative embodiment.

### DETAILED DESCRIPTION

The present invention will now be described in detail with reference to the Figures.

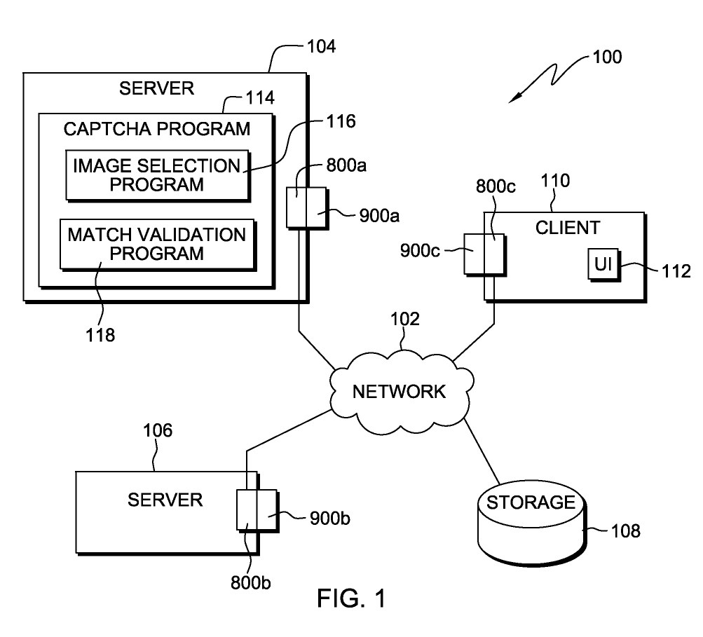

FIG. 1 depicts an illustrative diagram of a data processing environment as a network of data processing systems in which illustrative embodiments may be implemented. It should be appreciated that FIG. 1 provides only an illustration of one implementation and does not imply any limitations with regard to the environments in which different embodiments may be implemented. Many modifications to the depicted environments may be made.

Network data processing system 100 comprises a network of computers in which an embodiment may be implemented. Network data processing system 100 contains network 102, which acts as a medium for providing communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. Server computers 104 and 106 may be, for example, a server computer system such as a management server, a web server, or any other electronic device or computing system capable of receiving and sending data. In another embodiment server computer 104 may represent a server computing system utilizing multiple computers as a server system, such as in a cloud computing environment.

Client computer 110 connects to network 102. Client computer 110 may be, for example, a client computer system such as a notebook, a laptop computer, a tablet computer, a handheld device or smart-phone, a thin client, or any other electronic device or computing system capable of communicating with a server computer system, such as server computers 104 and 106, through a network. In the depicted example, server computer 104 provides information, such as boot files, operating system images, and applications to client computer 110. Client computer 110 acts as a client to server computer 104 in this example. Client computer 110 may contain user interface (UI) 112. UI 112 may process and display received and selected image information, as well as accept data entry from a user. UI 112 may be, for example, a graphical user interface (GUI) or a web user interface (WUI). Network data processing system 100 may include additional server computers, client computers, displays and other devices not shown.

CAPTCHA program 114 protects a computer resource accessible to client computer 110, such as a database, application, or some other program by only allowing access if a user trying to access the protected resource is determined to be a human. CAPTCHA program 114 sends image information to client computer 110 and receives from client computer 110 input used to determine whether or not to allow access to the protected resource. CAPTCHA program 114 may also run image selection program 116, for selecting an image and a portion of the image for use by CAPTCHA program 114, and match validation program 118, for determining if a received input matches criteria for allowing access.

In one embodiment, CAPTCHA program 114 runs on server computer 104, as where CAPTCHA program 114 is a web-based program on a web server accessible to many clients attempting to access the protected resource. In one embodiment the protected resource also resides on server computer 104. In another embodiment, the protected resource may reside on server computer 106, and server computer 106 may in turn act as a relay between CAPTCHA program 114 on server computer 104 and client computer 110 to determine if access to the protected resource on server computer 106 should be granted to client computer 110.

Data gathered, generated, and maintained for use by CAPTCHA program 114 may be stored on server computer 104 or storage unit 108.

Server computers 104 and 106, and client computer 110, each maintain respective internal components 800a, 800b, and 800c, and respective external components 900a, 900b, and 900c.

In the depicted example, network data processing system 100 is the internet with network 102 representing a worldwide collection of networks and gateways that use the Transmission Control Protocol/Internet Protocol suite of protocols to communicate with one another. Network data processing system 100 may also be implemented as a number of different types of networks, such as, for example, an intranet, a local area network (LAN), or a wide area network (WAN). FIG. 1 is intended as an example, and not as an architectural limitation for the different embodiments.

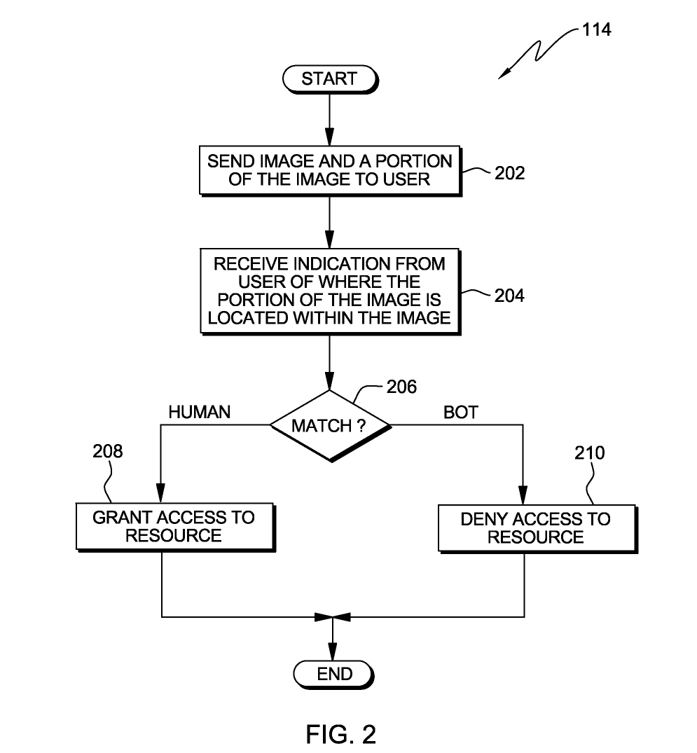

FIG. 2 depicts a flowchart of the steps of CAPTCHA program 114 for determining if a user of a client computer system is a human or a computer program in accordance with an illustrative embodiment.

In step 202, CAPTCHA program 114 sends an image and a portion of the image to a user. The user may be a user of any other computing system attempting to access a protected resource. A protected resource may be, for example, a database, program, or other application. The user may be a human or a bot.

CAPTCHA program 114 receives from the user an indication of the location within the image where the portion of the image was selected from (step 204). In one embodiment, the user may make this indication by clicking (selecting with a mouse pointer) the image at a desired location. In one such embodiment, CAPTCHA program 114 receives the indication as a set of (x, y) coordinates where the user clicked.

In response to the received indication, CAPTCHA program 114 determines whether there is a match (decision block 206) between the indicated location and the portion of the image.

If there is a match, CAPTCHA program 114 determines that the user is a human and grants access to the protected resource (step 208). If there is not a match, CAPTCHA program 114 determines that the user is a bot and denies access to the protected resource (step 210). CAPTCHA program 114 ends after either step 208 or step 210.

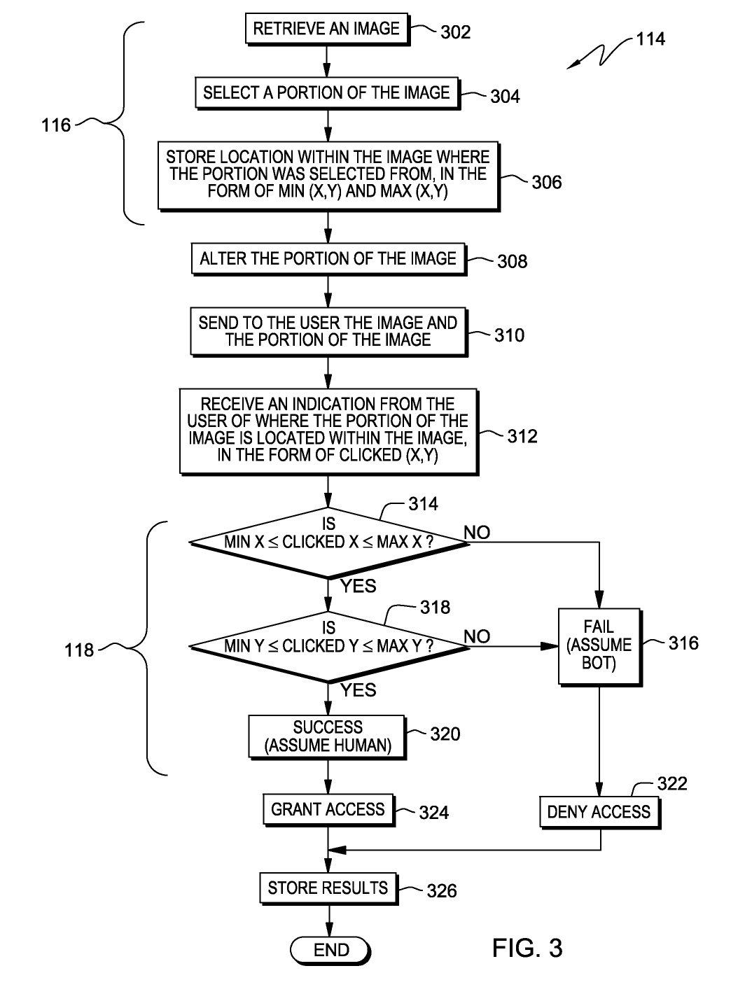

FIG. 3 depicts a preferred embodiment of CAPTCHA program 114 for determining if a user of a client computer system is a human or a computer program.

CAPTCHA program 114 retrieves an image (step 302). The image may be retrieved from a local database of images or may be found on a network or the internet. In one embodiment, CAPTCHA program 114 retrieves a random image. Alternatively, CAPTCHA program 114 may retrieve only certain types of images, such as portraits or images of a predetermined difficulty level.

CAPTCHA program 114 selects a portion of the image (step 304). The selected portion may vary in size and shape. In one embodiment, the portion meets some predefined level of contrast to ensure that a human user can distinguish the portion from another portion of the image. In another embodiment, CAPTCHA program 114 selects the portion randomly. In another embodiment still, for each retrieved image there exist predetermined portions of the image that CAPTCHA program 114 may select from. In such an embodiment CAPTCHA program 114 may select the portion randomly from the predetermined portions, or, in an alternative embodiment, by a difficulty rating associated with each predetermined portion. The selected portion of the image becomes a separate and distinct image which may later be presented alongside the original image.

In other embodiments, CAPTCHA program 114 may select multiple portions of the image. In such embodiments, wherever a subsequent step performs an action concerning a portion of the image, the subsequent step may perform the action upon a plurality of portions of the image.

CAPTCHA program 114 stores the location within the image where the portion was selected from (step 306). In a preferred embodiment, CAPTCHA program 114 divides the image into a grid of (x, y) coordinates. The grid may be as small as pixilation allows. CAPTCHA program 114 may store the location in a variety of ways, including, but not limited to, by saving every valid coordinate pair, by saving a minimum (x, y) coordinate pair and a maximum (x, y) coordinate pair (a preferred embodiment), or by saving an equation or equations which represent/approximate the selected portion based on an (x, y) plane.

Collectively, steps 302, 304 and 306 may comprise image selection program 116 within CAPTCHA program 114.

CAPTCHA program 114 alters the portion of the image (step 308). To prevent a bot from doing a bit by bit comparison of the image and the portion of the image to determine the location within the image where the portion was selected from, before sending the image and the portion of the image to a user, CAPTCHA program 114 may perform one or more of the following transformations: rotate the portion, flip horizontally/vertically/diagonally, stretch or reduce across an axis, change color/texture, replace content, and reshape the portion in a variety of ways. In one embodiment the “replace content” transformation may be taken as far as replacing the entire portion of the image with another predetermined image representative of the same location. For example, if the portion of the image shows a person's eyes, the portion may be replaced with cartoon eyes.

After altering the portion of the image, CAPTCHA program 114 sends to the user the image and the portion of the image (step 310). The images display on the computer the user operates from.

CAPTCHA program 114 receives an indication from the user of the location within the image where the portion was selected from (step 312). In an embodiment where CAPTCHA program 114 sends only one portion of the image to the user, CAPTCHA program 114 may receive coordinates from a click selecting the location. In an embodiment where CAPTCHA program 114 sends multiple portions of the image to the user, CAPTCHA program 114 may receive paired selections of a click on a portion of the image and the coordinates of the next click selecting the location. In a preferred embodiment, CAPTCHA program 114 receives the indication in a clicked (x, y) coordinate pair.

In a preferred embodiment, where the stored location is represented by a minimum (x, y) pair and a maximum (x, y) pair, after CAPTCHA program 114 receives the indication from the user, CAPTCHA program 114 determines whether minimum (x) of stored location is less than or equal to clicked (x) which is less than or equal to maximum (x) of stored location (min x≦clicked x≦max x) (decision block 314). If this statement is true, then CAPTCHA program 114 determines whether min y≦clicked y≦max y (decision block 318). If this statement is also true, CAPTCHA program 114 registers a validation success (step 320) in which CAPTCHA program 114 assumes the user is a human. If either decision block 314 or decision block 318 is answered in the negative, CAPTCHA program 114 registers a validation fail (step 316) in which CAPTCHA program 114 assumes the user is a bot.

In other embodiments CAPTCHA program 114 may use other methods to determine whether the user indication was correct. CAPTCHA program 114 may also widen the acceptable click area outside of the actual parameters of the location within the image. This expanded click area may be referred to as a tolerance region. CAPTCHA program 114 may have a set tolerance region, or may increase/decrease the tolerance region based on success and failure rates.

Collectively, decision block 314 through step 320 may comprise match validation program 118 within CAPTCHA program 114.

In response to the user properly indicating the location within the image where the portion was selected from (registered validation success in step 320), CAPTCHA program 114 grants the user access (step 324) to the resource.

In response to the user not properly indicating the location within the image where the portion was selected from (registered validation failure in step 316), CAPTCHA program 114 denies the user access (step 322).

After CAPTCHA program 114 has either denied access (step 322) or granted access (step 324), CAPTCHA program 114 stores results (step 326). Results may include any registered difficulty rating, success or failure, if failure—relative distance of the miss, and other determinable metrics.

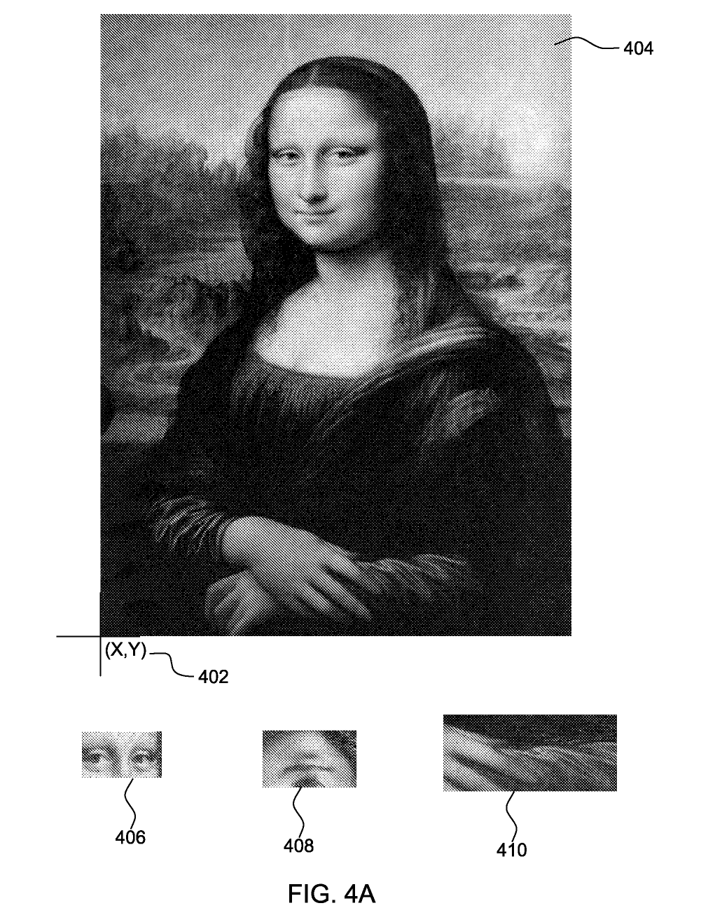

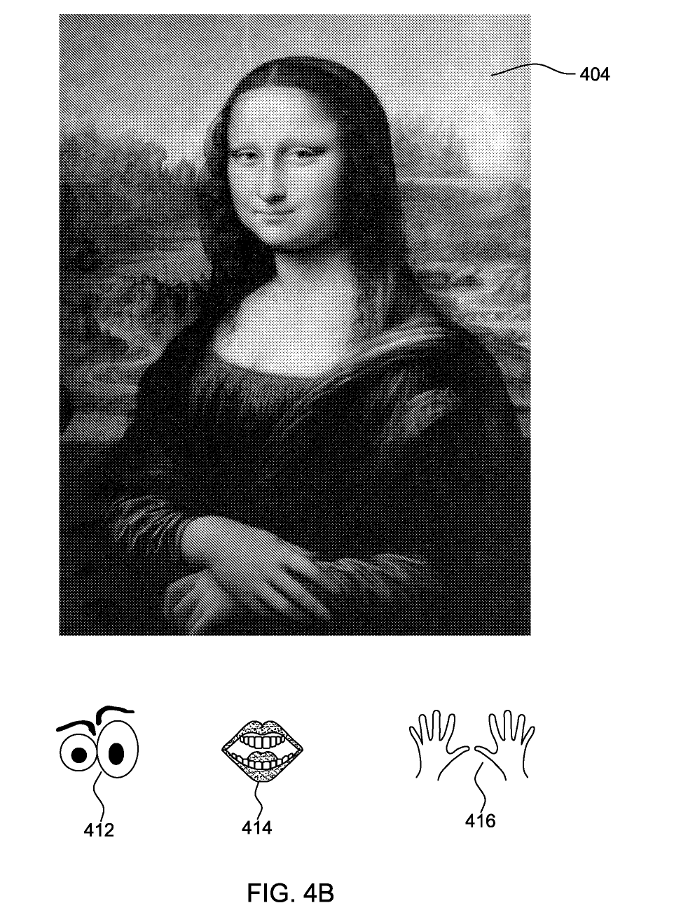

FIG. 4A depicts a user display where an image is displayed along with portions of the image that have been altered in various ways. FIG. 4B shows the same image, but instead the content of the portions of the image has been replaced with different images, which still correspond to a location within the image.

XY axis 402 depicts how an image may placed on an (x, y) grid so that a program, such as CAPTCHA program 114, may determine location within the image. The actual XY axis, plane, or grid will, in a preferred embodiment, be unseen to a user.

Image 404 is exemplary of any image which a program, such as CAPTCHA program 114, may retrieve for use by the program.

Portions 406, 408, and 410 represent different distinct portions or sections of image 404. Portion 406 shows eyes that have been reversed (the minor image) and shrunken along the x axis. Portion 408 shows the mouth shown in image 404. In this instance, there has been no stretching or shrinking, the portion was merely turned upside down. Portion 410 shows a section of image 404 which includes fingers or parts of a hand. Portion 410 has been stretched along the x axis. Portions 406, 408, and 410 may in other embodiments be rotated, stretched and skewed in different ways.

In this embodiment, a user would indicate the portion and the location from which the portion was selected within image 404. A user may first click the location and then the corresponding portion, or a user may first click the portion and then the corresponding location.

In 4B, portions 406, 408, and 410 have been replaced with images 412, 414, and 416. Image 412 shows cartoon eyes. When determining if the correct location has been indicated by the user for image 412, a program may use the same location corresponding to the replaced portion 406, as this represents the area of the eyes. Similarly, image 414 (showing a cartoon mouth) may correspond to the location corresponding to portion 408. In other embodiments, the permissible location may be widened or reduced. For example, the corresponding location to portion 410 would be an acceptable selection for image 416 (showing cartoon hands); however, the location may be expanded to include the totality of the Mona Lisa's hands, and possibly the surrounding areas, in image 404.

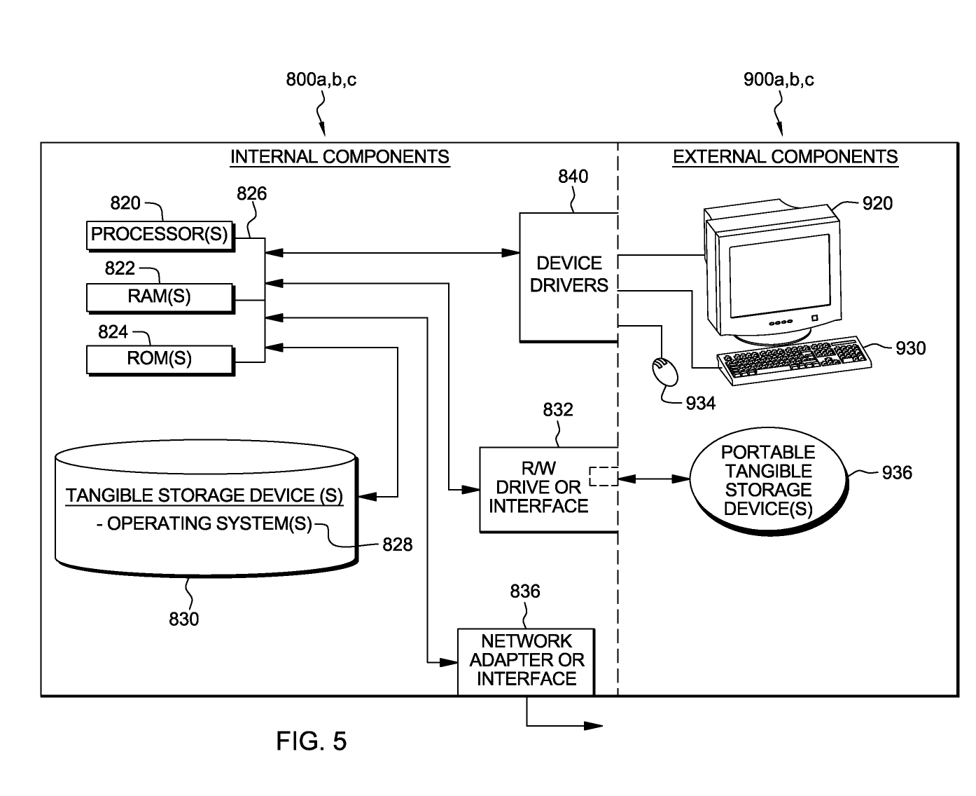

FIG. 5 depicts a block diagram of internal and external components of a data processing system depicted in accordance with an illustrative embodiment.

Server computers 104 and 106, and client computer 110, include respective sets of internal components 800a,b,c and external components 900a,b,c, illustrated in FIG. 5. Each of the sets of internal components 800a,b,c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and CAPTCHA program 114, image selection program 116, and match validation program 118 (for server computer 104), and any other programs for server computer 104, server computer 106, and client computer 110 are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b,c also includes a R/W drive or interface 832 to read from and write to one or more portable computer-readable tangible storage devices 936 such as a CD-ROM, DVD, memory stick, magnetic tape, magnetic disk, optical disk or semiconductor storage device. CAPTCHA program 114, image selection program 116, and match validation program 118 (for server computer 104), and any other programs for server computer 104, server computer 106, and client computer 110 can be stored on one or more of the respective portable computer-readable tangible storage devices 936, read via the respective R/W drive or interface 832 and loaded into the respective hard drive 830.

Each set of internal components 800a,b,c also includes a network adapter or interface 836 such as a TCP/IP adapter card. CAPTCHA program 114, image selection program 116, and match validation program 118 (for server computer 104), and any other programs for server computer 104, server computer 106, and client computer 110 can be downloaded to the respective computers from an external computer via a network (such as network 102) and network adapter or interface 836. From the network adapter or interface 836, CAPTCHA program 114, image selection program 116, and match validation program 118 (for server computer 104), and any other programs for server computer 104, server computer 106, and client computer 110 are loaded into the respective hard drive 830. The network may comprise copper wires, optical fibers, wireless transmission, routers, firewalls, switches, gateway computers and/or edge servers.

Each of the sets of external components 900a,b,c includes a computer display monitor 920, a keyboard 930, and a computer mouse 934. Each of the sets of internal components 800a,b,c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

CAPTCHA program 114, image selection program 116, and match validation program 118 (for server computer 104), and any other programs for server computer 104, server computer 106, and client computer 110 can be written in various programming languages (such as Java, C++) including low-level, high-level, object-oriented or non object-oriented languages. Alternatively, the functions of CAPTCHA program 114, image selection program 116, and match validation program 118 (for server computer 104), and any other programs for server computer 104, server computer 106, and client computer 110 can be implemented in whole or in part by computer circuits and other hardware (not shown).

Based on the foregoing, a computer system, method and program product have been disclosed for determining if a user of a client computer system is a human or a computer program. However, numerous modifications and substitutions can be made without deviating from the scope of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. Therefore, the present invention has been disclosed by way of example and not limitation.

What is claimed is:

1. A method for determining if a user of a client computer system is a human or a computer program, the method comprising the steps of:
a server computer system sending to the client computer system an image and a portion of the image for display on the client computer system, wherein the portion of the image is selected from a location within the image;
the server computer system receiving from the user an indication of the location;
in response to the user properly indicating the location, the server computer system determining that the user of the client computer system is a human; and
in response to determining that the user of the client computer system is a human, the server computer system granting the user access to a computer resource.

2. The method of claim 1, wherein the computer resource is selected from the group consisting of a database and a computer program.

3. The method of claim 1, further comprising the steps of:
the server computer system sending to a second client computer system a second image and a portion of the second image for display on the second client computer system, wherein the portion of the second image is copied from a location within the second image;
the server computer system receiving from a user of the second client computer system an indication of the location within the second image;
in response to the user of the second client computer system not properly indicating the location within second image, the server computer system determining that the user of the second client computer system is a computer program; and
the server computer system denying the user of the second client computer system access to the computer resource.

4. The method of claim 1, further comprising the steps of:
before the step of sending to the client computer system the image and the portion of the image for display on the client computer system:
the server computer system retrieving the image;
the server computer system selecting the portion of the image; and
the server computer system storing the location within the image where the portion of the image is selected from.

5. The method of claim 1, further comprising the step of:
before the step of sending to the client computer system the image and the portion of the image for display on the client computer system, the server computer system altering the portion of the image.

6. The method of claim 5, wherein the portion of the image comprises an image of a recognizable object, and wherein the step of altering the portion of the image further comprises the server computer system replacing the image of the recognizable object with another image.

7. The method of claim 4, wherein the step of storing the location further comprises the steps of:
the server computer system dividing the image into a grid of (x, y) coordinates; and
the server computer system determining the location as a set of the grid coordinates.

8. The method of claim 1, further comprising the step of the server computer system storing results comprising one or more of a difficulty rating, whether the user was determined to be a human or a computer program, an updated success rate, an updated failure rate, and a distance of the indication from the location within the image where the portion was selected from.

9. A computer program product comprising one or more computer-readable tangible storage devices and computer-readable program instructions which are stored on the one or more storage devices and when executed by one or more processors of the server computer system of claim 1 perform the method of claim 1.

10. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 1.

11. A computer program product for determining if a user of a client computer system is a human or a computer program, the computer program product comprising:
one or more computer-readable tangible storage devices and program instructions stored on at least one of the one or more storage devices, the program instructions comprising:
program instructions to send to the client computer system an image and a portion of the image for display on the client computer system, wherein the portion of the image is selected from a location within the image;
program instructions to receive from the user an indication of the location;
in response to the user properly indicating the location, program instructions to determine that the user of the client computer system is a human;
in response to determining that the user of the client computer system is a human, program instructions to grant the user access to a resource;
in response to the user not properly indicating the location within image, program instructions to determine that the user is a computer program; and
in response to determining that the user is a computer program, program instructions to deny the user access to the resource.

12. The computer program product of claim 11, wherein the resource is selected from the group consisting of a database and a computer program.

13. The computer program product of claim 11, further comprising program instructions, stored on at least one of the one or more storage devices, to:
retrieve the image;
select the portion of the image; and
store the location within the image where the portion of the image is selected from.

14. The computer program product of claim 11, further comprising program instructions, stored on at least one of the one or more storage devices, to alter the portion of the image.

15. The computer program product of claim 14, wherein the portion of the image comprises an image of a recognizable object, and wherein the program instructions to alter the portion of the image, replace the image of the recognizable object with another image.

16. The computer program product of claim 13, wherein the program instructions to store the location:
divide the image into a grid of (x, y) coordinates; and
determine the location as a set of the grid coordinates.

17. The computer program product of claim 11, further comprising program instructions, stored on at least one of the one or more storage devices, to store results comprising one or more of a difficulty rating, whether the user was determined to be a human or a computer program, an updated success rate, an updated failure rate, and a distance of the indication from the location within the image where the portion was selected from.

18. A computer system for determining if a user of a client computer system is a human or a computer program, the computer system comprising:
one or more processors, one or more computer-readable memories, one or more computer-readable tangible storage devices and program instructions which are stored on the one or more storage devices for execution by the one or more processors via the one or more memories, the program instructions comprising:
program instructions to send to the client computer system an image and a portion of the image for display on the client computer system, wherein the portion of the image is selected from a location within the image;
program instructions to receive from the user an indication of the location;
in response to the user properly indicating the location, program instructions to determine that the user of the client computer system is a human;
in response to determining that the user of the client computer system is a human, program instructions to grant the user access to a computer resource;
in response to the user not properly indicating the location within image, program instructions to determine that the user is a computer program; and
in response to determining that the user is a computer program, program instructions to deny the user access to the resource.

19. The computer system of claim 18, wherein the resource is selected from the group consisting of a database and a computer program.

20. The computer system of claim 18, further comprising:
program instructions, stored on at least one of the one or more storage devices for execution by at least one of the one or more processors via at least one of the one or more memories, to:
retrieve the image;
select the portion of the image; and
store the location within the image where the portion is selected from.

21. The computer system of claim 18, further comprising:
program instructions, stored on at least one of the one or more storage devices for execution by at least one of the one or more processors via at least one of the one or more memories, to alter the portion of the image.

22. The computer system of claim 21, wherein the portion of the image comprises an image of a recognizable object, and wherein the program instructions to alter the portion of the image, replace the image of the recognizable object with another image.

23. The computer system of claim 20, wherein the program instructions to store the location:
divide the image into a grid of (x, y) coordinates; and
determine the location as a set of the grid coordinates.

24. The computer system of claim 18, further comprising:
program instructions, stored on at least one of the one or more storage devices for execution by at least one of the one or more processors via at least one of the one or more memories, to store results comprising one or more of a difficulty rating, whether the user was determined to be a human or a computer program, an updated success rate, an updated failure rate, and a distance of the indication from the location within the image.
